(19) United States
(12) Patent Application Publication
(10) Pub. No.: US 2012/0186737 A1
(43) Pub. Date: Jul. 26, 2012

(54) Adhesive camouflage

(76) Inventors: Robert Van Burdine, Ardmore, TN (US); Dorothy Devine Burdine, Ardmore, TN (US)

(21) Appl. No.: 13/374,880

(22) Filed: Jan. 20, 2012

Related U.S. Application Data
(60) Provisional application No. 61/461,930, filed on Jan. 25, 2011.

(51) Int. Cl. B32B 38/10; B32B 37/12

(52) U.S. Cl. 156/249; 156/60

(57) ABSTRACT

The present invention provides a method of camouflaging an object using matter from the local environment by adhering the matter to or about the object rendering the object less distinguishable from and therefore camouflaged in the local environment. The matter may be adhered to a secondary and separate drape provided for covering the object.

### REFERENCES CITED

| | | |
|---|---|---|
| 4,644,987 | February 1987 | Kiang |
| 4,868,019 | September 1989 | Knickerbroker |
| 5,615,508 | April 1997 | Miller |
| 5,778,590 | July 1998 | Browning |
| 6,699,803 | March 2004 | Muirhead |
| 7,476,438 | January 2009 | Gorres |
| 7,682,661 | March 2010 | Lauer |
| 7,731,052 | June 2010 | Rappaport |

### CROSS-REFERENCE TO RELATED APPLICATIONS

This application claims benefit of U.S. Provisional Patent Application No. 61/461,930, filed on Jan. 25, 2011 and entitled “Adhesive camouflage,” in the names of Robert Van Burdine and Dorothy Devine Burdine, which is hereby incorporated by reference in its entirety.

### FIELD OF THE INVENTION

The present invention relates to the field of camouflage, and in particular to a method for creating a camouflage of local matter adhering on an object coated with an adhesive.

### SUMMARY OF THE PREFERRED EMBODIMENTS OF THE PRESENT INVENTION

The visible surface of an object is made camouflageable by coating or covering with a sticky substance such as an adhesive. In this manner, the local environmental matter such as sand, soil, grass or leaves may be brought or otherwise come in contact with the adhesive and stick to the surface, effectively camouflaging the object, and the object can be readily camouflaged in any environment. Adhesives of any type may be used including pressure-sensitive adhesives such as acrylate copolymers and contact cements.

The adhesive may be rippled or roughened, or a mat or screen of loose fabric or other structure may be embedded in the adhesive to provide for a larger adhesion area. In this manner larger or irregular objects may be adhered to the surface more readily. A mat or screen pressed into the surface of a thicker adhesive lay also provides surface strength when attaching heaver camouflaging matter such as stones or sticks.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art, and should not be interpreted in an idealized or overly formal sense unless expressly so defined herein. Well-known functions or constructions may not be described in detail for brevity and/or clarity. For the present invention, the term “object” is taken to mean any visible surface, visible expression of a solid material, matrix of solid materials, any thing that is visible, and gasses and liquids that can be said to be differentiated from the local environment. Commonly known objects comprise such items as equipment, clothing, uniforms, hats, helmets, vehicles, weapons, structures, buildings, tanks, cylinders, sheets, plastic sheeting, netting, area denial devices, equipment, stones, masonry and wood constructs among others. These terms are interchangeable with the term “object” and have the same meaning for the present invention. For the present invention, the term “adhesive” refers to a glue or sticky substance that can adhere, stick or bond items together on a permanent or temporary basis. The term “adhesive” includes drying, pressure sensitive, contact, heated, reactive, single part, multi part, natural and synthetic adhesive materials. Materials that may form an adhesive surface include gels, gelatins, syrups, oils, waxes, liquids, solids, glues, mixtures, cements, compositions, acrylate copolymers, cyanoacrylates, drying adhesives, shrinking adhesives, pressure sensitive adhesives, contact cements, contact adhesives, reactive adhesives, thermally plastic adhesives, thermally setting adhesives, liquids, solvents, synthetics, chemicals, compounds, reactants, one and multipart adhesives, natural and synthetic adhesives, resins, hardeners, emulsions and any material that will adhere to a surface and provide a tacky or sticky surface for the adherence of local surface matter. These terms are interchangeable with the term “adhesive” and have the same meaning for the present invention. For the present invention the term “matter” includes all local and surface matter including all materials, natural and manmade, that may be resident in the local area of the object to be camouflaged. Examples of “matter” include but are not limited to leaves, sand, earth, dust, sticks, bark and stones. For the present invention, the term “drape” refers to a covering means external to the object and covering some or all of the object.

Any object can be camouflaged by means of the present invention. For example, an object such as a suitably equipped game camera may be camouflaged by the application of an adhesive to its surface and the subsequent adhesion of bark, leaves and twigs. The adhesive may be removed by a solvent and the camera camouflaged again whenever the camera is moved to another location. Alternatively, the camera can be covered by a drape coated with an adhesive to which bark and leaves, or other natural matter in the area, are attached by sticking to the adhesive drape. In this manner the camera would be well matched to its surroundings.

In another example a firearm, such as a rifle, can be draped with a form fitting covering that has an adhesive outer surface. If the firearm is being used in a desert environment this adhesive surface can be covered in the local sand causing the adhesive surface to be coated in sand. In this manner the rifle would be effectively camouflaged when the covering is applied. A helmet, backpack, uniform or other equipment may be camouflaged in a similar manner.

In another example, an object may be configured to self apply adhesive facilitating the coating of the vehicle or structure with local matter providing camouflage.

In the case of a stationary field equipment such as a surface device or communications equipment, the adhesive applied to the surface may be selected to continue to collect local matter such as sand and leaves as they are blown by the wind against the equipment. When such equipment is automatically deployed, a means may be provided to initially splash the sticky visible surfaces with local matter causing an immediate coating of camouflaging matter, or in windy environments allow the equipment to self-camouflage as matter is blown against the sticky surfaces. The equipment may be deployed in such a manner that it rolls or tumbles before coming to rest exposing the adhesive surfaces to local matters and adhering them to the equipment providing camouflage.

In the case of a sand or dust environment such as a desert, the visible surfaces of the deployed objects such as equipment can be rendered adhesive to the local surface matter by coating with an appropriate adhesive that remains tacky for an extended period of time and would tend to allow wind blown local matter such as dust and sand to stick to the surface and accumulate. In this manner the equipment object is made self-camouflaging.

By initially camouflaging the object with a paint or other method of standard camouflage, and then rendering selected surfaces adhesive to local matter, the overall camouflaging effect can be much improved.

Camouflaged clothing may be formed by this method with the exterior, visible surfaces of the clothing being rendered adhesive and local matter such as earth, sand and leaves adhered to the surface as required.

Equipment surfaces may be rendered adhesive by applying the adhesive at manufacture and covering the adhesive with a removable or degradable surface such that the adhesive surface can be protected and only exposed when a camouflaging action is desired. For example, a plastic film might be utilized to protect the surface until it is removed and the adhesive exposed. Likewise, a surface might have the adhesive covered by a coating that degrades and disappears in sunlight, or dissolves in water such as rain or dew, or that reacts with oxygen and evaporates, or otherwise is removed exposing the adhesive surface allowing the camouflaging action to begin.

An adhesive may be applied to the surfaces to be camouflaged when desired such as by the application of a liquid, spray, tape or film material. The adhesive may be comprised with a carrier substrate such as a tape or film and the application of these items to the object to be camouflaged and the exposure of the adhesive surfaces facilitates the method of camouflage of the present invention. Multiple overlapping layers may be applied and when the current camouflage is no loner appropriate that layer may be removed exposing a new layer of adhesive on which to apply new local matter for camouflage.

In the case of a granular matter such as sand and earth, it is preferred to employ an adhesive that will wick by capillary action between the grains further capturing more matter and providing a thickened and less transparent camouflaging layer.

While the method of this invention has been shown and described with reference to the specific embodiments noted herein it will be understood by those skilled in the art that many deviations, derivations and variations in form and specific details may be made therein without departing from the scope of the invention which is limited only by the claims annexed hereto.

### DISCUSSION OF THE PRIOR ART

Historically, concealment of objects in the field such as personnel, vehicles, tanks, ships, equipment, firearms, devices and munitions has always been of primary concern to hunters, wildlife observers and the military. Various means of camouflaging personnel and objects to make them less perceptible to prey and the enemy have been employed. The military uses camouflage to hide weapons and equipment from the enemy. In general, the primary goal of camouflage is to make the object blend into the environment.

The camouflage patterns and systems employed use a variety of different colors which generally match colors found in the environment in which the object to be concealed is located. In addition to the aspect of coloration, the various patterns or distributions of color tones on the surface of the object aid in confusing the visual perception of the intended observer.

A number of methods have been proposed to provide for a decorative or camouflaged surface on objects. Some such proposed methods are found in U.S. Pat. No. 5,792,516 to Beretta; U.S. Pat. No. 5,778,590 to Browning et al.; U.S. Pat. No. 5,615,508 to Miller et al.; U.S. Pat. No. 4,868,019 to Knickerbocker; U.S. Pat. No. 4,644,987 to Kiang; U.S. Pat. No. 2,339,317 to Ayers; U.S. Pat. No. 2,294,875 to Hexter et al.; U.S. Pat. No. 2,190,691 to Barclay; and U.S. Pat. No. 1,305,296 to Mackay.

In particular the method proposed by Browning et al. (U.S. Pat. No. 5,778,590) presents a protective cover for a long-barreled firearm, wherein the protective cover is made up of thin vinyl sheets, treated with application adhesive, bearing a camouflage design. Miller et al. (U.S. Pat. No. 5,615,508) discloses a decorative layer of fabric encapsulated by a layer of transparent fiberglass. Kiang (U.S. Pat. No. 4,644,987) describes a protective covering device for rifles comprising an integral fiber cloth sheet of elastic nature designed to fit the shape of a rifle stock. Barclay (U.S. Pat. No. 2,190,691) and Mackay (U.S. Pat. No. 1,305,296) describe camouflaging large military objects such as planes and ships, respectively through the use of paint and stencils, however they do not disclose an adhesive surface for the application of local matter producing custom camouflage on a surface, and in particular the surfaces of a firearm. Knickerbocker (U.S. Pat. No. 4,868,019) discloses preferred camouflage color schemes. Finally, Ayers (U.S. Pat. No. 2,339,317) and Hexter et al. (U.S. Pat. No. 2,294,875) both disclose coating materials for camouflage applications.

U.S. Pat. No. 7,731,052 describes a flexible configurationally conformable camouflaging and insulating cover for an exposed compressed gas tank having a colored semi-opaque camouflaging exterior covering and an inner insulating layer supported spacedly adjacent the tank by plural spacers. The cover is an exterior cover that has color and paternation that camouflages the cover and covered tank and causes the cover and covered tank to be less visually obvious in the tank surroundings. In this case the color and pattern have to be selected to best match the immediately surrounding environment.

U.S. Pat. No. 7,682,661 provides a pre-packaged kit and a method for creating unique multi-toned custom patterns or camouflage on a surface, and in particular the surfaces of a firearm. The multi-toned custom patterns or camouflage are created by separating or peeling off pre-cut stencil/templates from sheet or roll stock adhesive backed masking material and applying the stencil/templates to a surface. The surface is subsequently sprayed with coatings, finishers and sealants. Additional layers of stencil/templates are then added and sprayed with various colors or tones of coatings, finishers and sealants to complete the desired effect on the firearm surface.

In a similar manner U.S. Pat. No. 7,476,438 describes a self-adherent wrap containing a camouflage pattern and/or an active agent, as well as methods of making and using such self-adherent wraps.

Conversely, the present invention provides for an exact match of the local surroundings as it uses matter from the natural environment.

U.S. Pat. No. 6,699,803 describes a camouflage covering fabricated by the method of attaching dyed jute strands to netting, wherein the netting is placed over an individual or object to be camouflaged. The covering may be formed as an integral garment, such as a hooded poncho, or may be attached to clothing such as a battle dress uniform (BDU) to form a ghillie suit. The covering may be draped over an object such as a weapon, vehicle, equipment, or supplies. This disclosure is suitable for brush or grass but would not be effective for camouflage in sand environments. The present invention provides for the adhesion of grass, sticks, and sand as well.

In contrast to these conventional methods, the present invention provides for a method in which the surfaces of an object are rendered camouflaged directly by the covering of the object by local surface matter. This method provides a perfect match to the coloration and texture of the local matter and presents the closest possible match for concealment by camouflage.

The present invention is superior as it provides a method wherein a cover may be made adhesive and matter from the local environment may adhere to the cover rendering the cover an exact match for color and paternation.

The need for an effective camouflaging method is exemplified by the proliferation of attempts to produce better camouflage. Under the present invention, a simpler, more efficient, more effective, reliable, and possibly less costly method of achieving this end is disclosed.

### DESCRIPTION OF THE DRAWINGS

The present invention will now be described more fully hereinafter with reference to the accompanying figures, in which embodiments of the invention are shown. This invention may, however, be embodied in many different forms and should not be construed as limited to the embodiments set forth herein.

The invention will now be described by way of example only, with reference to the accompanying drawings in which:

FIG. 1 is a cross-sectional view of an object's surface with an adhesive applied with sand, a leaf and dust particles shown.

FIG. 2 is a cross-sectional view of an object's surface with an adhesive applied to a drape with leaves shown.

FIG. 3 is a cross-sectional view of a surface with an adhesive applied with a screen of structural material shown to provide apparent thickness to the adhesive.

FIG. 4 is a cross-sectional view of an object coated with a wicking adhesive adhering a thickened layer of sand providing enhanced camouflage.

FIG. 5 shows a rifle covered with an adhesive drape covered in local matter rendering the rifle camouflaged.

FIG. 6 shows a typical area denial device such as a land mine directly covered with an adhesive covered in local matter rendering the land mine camouflaged.

### DETAILED DESCRIPTION OF THE PREFERRED EMBODIMENTS

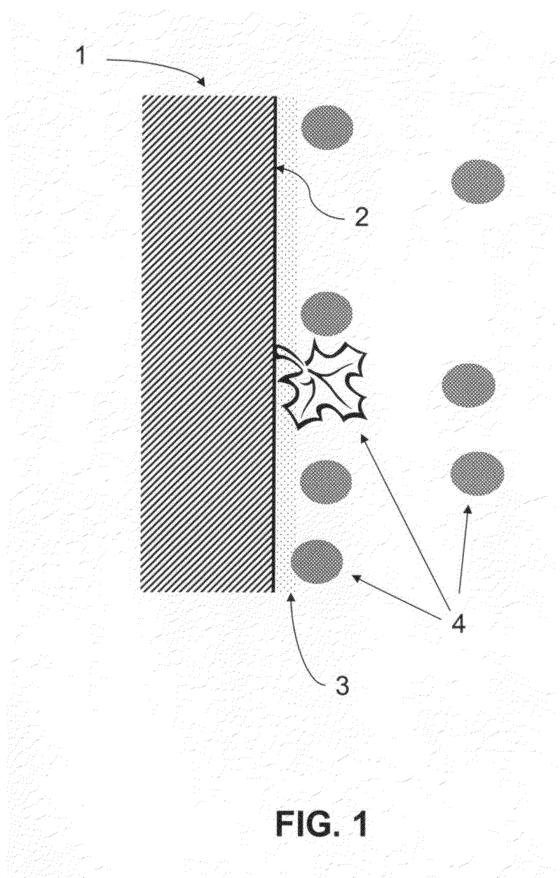

FIG. 1 is a cross-sectional view of an object 1 exhibiting a visible surface 2. Visible surface 2 is covered with adhesive layer 3 that allows local matter 4 represented by leaves and other matter to adhere themselves to layer 3. As the local matter 4 accumulates and sticks to adhesive layer 3, the object 1 becomes camouflaged.

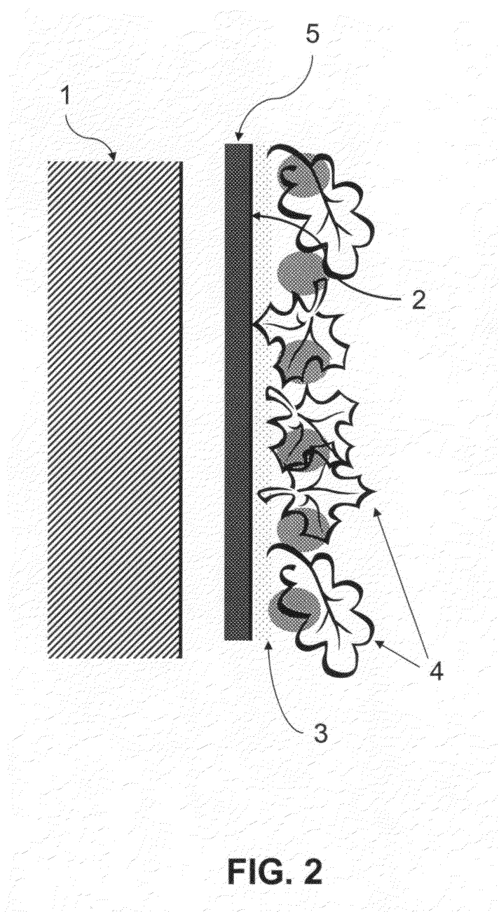

FIG. 2 is a cross-sectional view of a drape material 5 presenting an exterior visible surface 2 coated with an adhesive 3. Local matter 4 adheres to adhesive 3 forming a camouflaging layer. Object 1 is covered by drape material 5 and is thereby camouflaged. Drape material 5 may be any material including a flexible material such as netting, fabric, plastic sheeting, paper, metal or other woven, rigid or flexible material as desired. Drape material 5 may also be a non-flexible material such as wood or hard plastic.

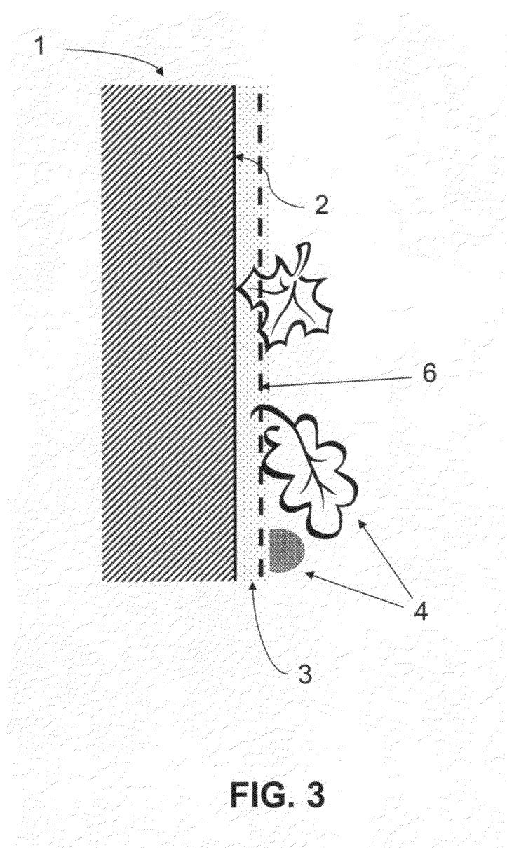

FIG. 3 is a cross-sectional view of an object 1 exhibiting a visible surface 2. Visible surface 2 is covered with adhesive layer 3 that causes local matter 4 represented by leaves and other matters to adhere themselves to layer 3. Mat 6 is embedded in adhesive layer 3 to provide structural support and provide an uneven or roughened surface facilitating the adherence of local matter 4. As the local matter 4 accumulates and sticks to adhesive layer 3, the object 1 becomes camouflaged.

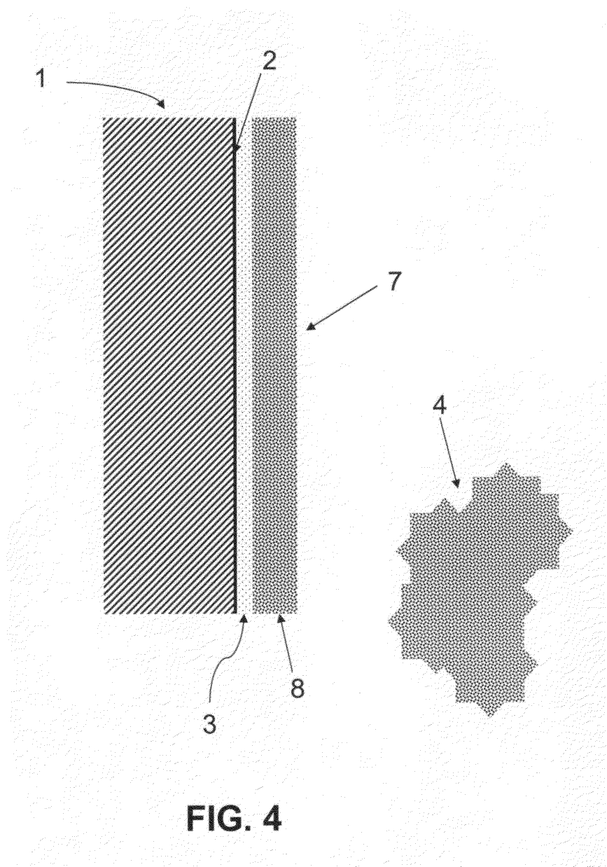

FIG. 4 is a cross-sectional view of an object 1 exhibiting a visible surface 2. Visible surface 2 is covered with adhesive layer 3 that facilitates local matter 4 represented by sand 7 to adhere to layer 3. The adhesive 3 is selected to wick or spread around the sand particles 7 forming a completely bound layer 8 of sand particles 7 several layers thick forming a camouflaging layer for the object.

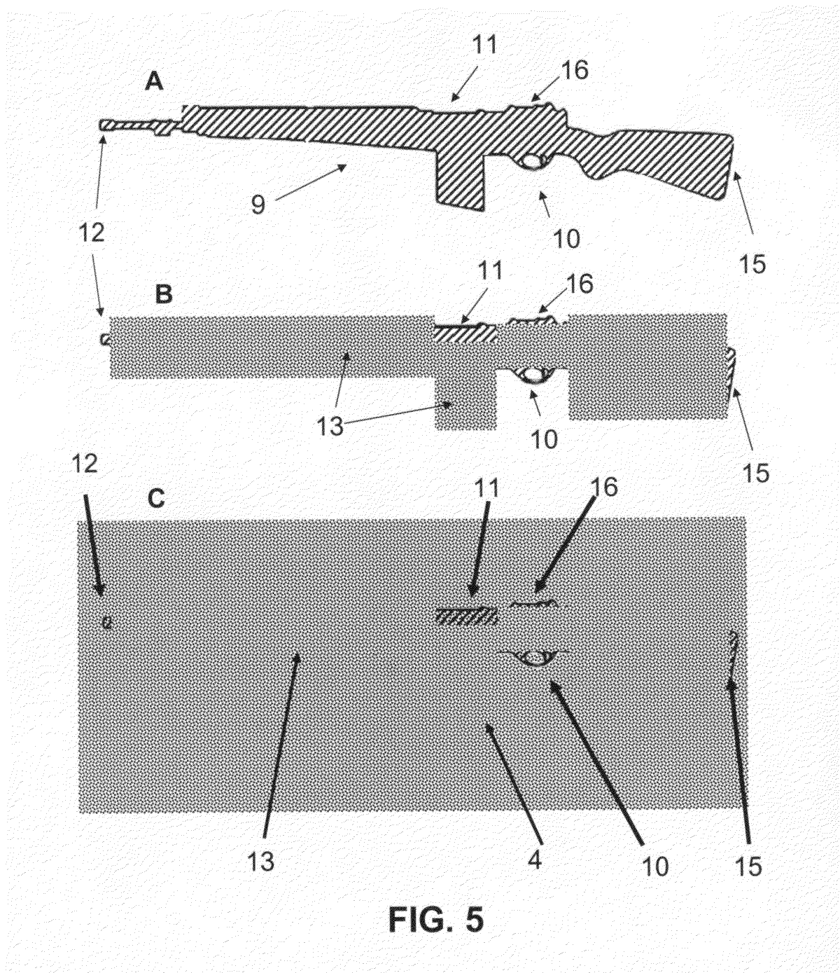

FIG. 5 is a view of a typical military rifle 9 comprising trigger 10, muzzle 12, breech 11, sights 16 and stock 15. In view A the rifle 9 is shown without camouflage. In view B the rifle 9 is covered with a drape 13. Drape 13 is coated with an adhesive on its outer surface and is comprised with cutouts for the operation of rifle 9 exposing trigger 10, muzzle 12, breech 11, sights 16 and stock 15. The drape 13 is coated with local matter 4. Local matter 4 may be leaves, sand, or any typical matter in the area as desired. Local matter 4 sticks to the adhesive side of drape 13 rendering drape 13 camouflaged, and rifle 9 camouflaged by action of being covered by drape 13. In view C rifle 9 covered by drape 13 is seen against local matter 14 and is not distinguishable except for the exposed working rifle 9 items trigger 10, muzzle 12, breech 11, sights 16 and stock 15.

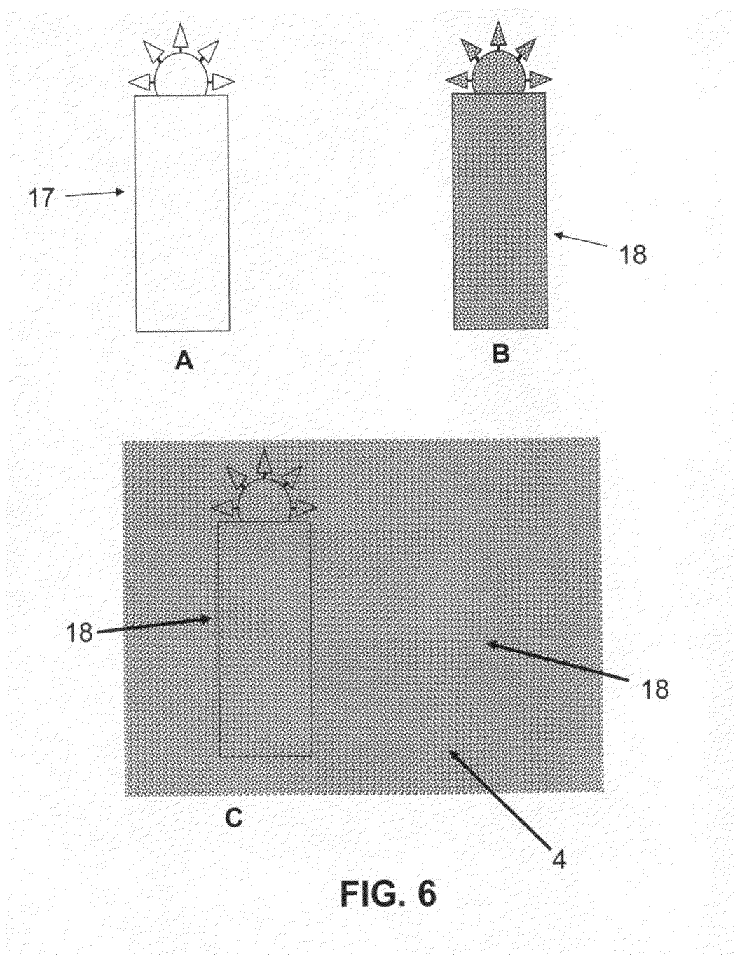

FIG. 6 shows a typical area denial device as represented by a military land mine 17. Land mine 17 in view A is not camouflaged and is visible. View B shows land mine 17 covered with adhesive 18 and adhesive 18 is coated and retains by sticking to local matter 4. View C shows land mine 17 coated with adhesive 18 retaining local matter 18 as seen against local matter 4. Land mine 17 is not readily visible as it blends in perfectly with local matter 4.

We claim:

1. A method of camouflaging an object comprising the steps of applying an adhesive to the visible surface of an object, applying local matter to the adhesive, the local matter sticking to the adhesive.

2. The method of claim 1 where the local matter is applied to the adhesive by the forces of nature, wind and water action.

3. The method of claim 1 where the local matter is applied to the adhesive by the motion of the object.

4. The method of claim 1 where the adhesive is applied to the object, the adhesive covered by a protective covering, the protective covering removed exposing the adhesive, applying local matter to the adhesive, the local matter sticking to the adhesive.

5. The method of claim 1 where the object applies the adhesive.

6. A method of camouflaging an object comprising the steps of coating a drape with adhesive, applying the drape over selected visible surfaces of the object, applying local matter to the adhesive, the local matter sticking to the adhesive.

7. The method of claim 4 where the adhesive covering the drape is on one side of the drape only.

8. The method of claim 4 where the adhesive on the drape is covered by a protective covering, the protective covering removed exposing the adhesive, applying local matter to the adhesive, the local matter sticking to the adhesive.
